(19) United States
(12) Patent Application Publication
(10) Pub. No.: US 2024/0064642 A1
(43) Pub. Date: Feb. 22, 2024

(54) METHOD OF COMMUNICATION DEVICE AND COMMUNICATION DEVICE

(71) Applicant: Samsung Electronics Co., Ltd., Suwon-si (KR)

(72) Inventors: Pengru LI, Beijing (CN); Min WU, Beijing (CN); Feifei SUN, Beijing (CN)

(21) Appl. No.: 18/451,453

(22) Filed: Aug. 17, 2023

(30) Foreign Application Priority Data
Aug. 18, 2022 (CN) 202210994052.X

(51) Int. Cl. H04W 52/02; H04W 68/02; H04W 76/20; H04W 72/1273

(52) U.S. Cl. CPC H04W 52/0235; H04W 68/02; H04W 76/20; H04W 72/1273

(57) ABSTRACT

The disclosure relates to a 5G or 6G communication system for supporting a higher data transmission rate. A method performed by a user equipment (UE) in a communication system is provided. The method includes monitoring a wake-up signal and determining whether to wake up to receive paging-related information or establish radio resource control (RRC) connection or receive a physical downlink shared channel (PDSCH) based on the result of monitoring the wake-up signal.

### CROSS-REFERENCE TO RELATED APPLICATION(S)

This application is based on and claims priority under 35 U.S.C. § 119(a) of a Chinese patent application number 202210994052.X, filed on Aug. 18, 2022, in the Chinese Intellectual Property Office, the disclosure of which is incorporated by reference herein in its entirety.

### BACKGROUND

### 1. Field

The disclosure relates to a communication field. More particularly, the disclosure relates to a low-power wake-up signal (LPWUS).

### 2. Description of Related Art

5^{th} generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEG) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “Beyond 4G networks” or “Post-long term evolution (LTE) systems”.

5G communication systems are implemented in higher frequency (mmWave) bands, e.g., 60 GHz bands to achieve a higher data rate. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a low-power wake-up signal (LPWUS).

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes monitoring a wake-up signal, and determining whether to wake up to receive paging-related information or establish radio resource control (RRC) connection or receive a physical downlink shared channel (PDSCH) based on the result of monitoring the wake-up signal.

In an implementation, wherein the UE monitors the wake-up signal continuously, or the UE monitors the wake-up signal during a predefined or preconfigured time period before a discontinuous reception (DRX) cycle.

In an implementation, wherein the predefined time period is determined based on the starting position of the DRX cycle and a preconfigured offset.

In an implementation, wherein determining whether to wake up to receive paging-related information or establish RRC connection or receive a physical downlink shared channel (PDSCH) based on the result of the monitoring of the wake-up signal, comprises at least one of the followings, at least one of the followings is performed if the UE monitors the related wake-up signal, the UE wakes up to monitor paging early indication (PEI) to determine whether to wake up at a paging occasion (PO) of the UE to receive a paging message, the UE receives part or all of information of the paging message transmitted by a data part of the wake-up signal in the current or the latest DRX cycle and wakes up, and/or receive the paging-related information in the PDSCH, the UE receives the paging-related information in the data part of the wake-up signal in the current or the latest DRX cycle and wake up to receive part of information of the paging message, the UE wakes up to establish RRC connection, the UE wakes up to receive an synchronization signal block (SSB), the UE wakes up to receive the PDSCH, the UE wakes up to monitor the physical downlink control channel (PDCCH).

In an implementation, wherein, if the UE monitors the wake-up signal and the wake-up signal indicates to the UE to receive the paging-related information or establish RRC connection or receive the PDSCH, then, the UE wakes up at the first or the latest time unit after receiving the wake-up signal to monitor or receive the paging-related information, or the UE wakes up at the starting position of the next wake-up signal cycle and monitor or receive the paging-related information.

The method according to an embodiment of the disclosure further comprises at least one of the following, if the duration for no wake-up signal detection is greater than or equal to a third threshold, the UE wakes up to receive the paging-related information, if the UE monitors the reference signal received power (RSRP) change of the wake-up signal is greater than or equal to a first threshold, or the absolute value of RSRP is less than or equal to a second threshold, the UE wakes up to receive the paging-related information, if the UE does not detect its PO or the UE monitors the PEI which indicates to the UE not to monitor the PO for a duration greater than or equal to a fourth threshold, the UE continues to monitor the wake-up signal.

In an implementation, wherein the paging-related information comprises at least one of the paging early indication (PEI), the paging occasion (PO) and the paging message.

In an implementation, wherein the wake-up signal comprises a synchronization part and a data part, and wherein the UE determines a signal sequence of the synchronization part by at least one of the followings, system information, at least one of identification information of a cell where the UE is located, identification information of the UE, and an index of a radio frame or time slot or symbol where the synchronization part is located, blind detection of the UE, the signal sequence configured during the latest time the UE was in radio resource control (RRC) connection state.

In an implementation, wherein the data part comprises part or all of indication information and/or the paging message to wake up the UE.

In an implementation, wherein an indication field of the data part comprises at least one of the following, a list of the paged UEs pagingRecordList comprising a UE identification ue-Identity and/or an access type accessType, a late non-critical extension lateNonCriticalExtension, a non-critical extension nonCriticalExtension, system information modification, an earthquake and tsunami warning system etwsAndCmaslndication and/or commercial mobile alarm service indication Commercial Mobile Alert Service, a stop paging monitoring stopPagingMonitoring indication.

In an implementation, wherein the data part comprises a UE-specific information block or a UE group information block group, wherein the UE group is at least one of the followings, a subgroup specified by a core network, a subgroup based on a UE identification (ID).

In an implementation, wherein the information block group is at least one of the following, length and/or format of each information block in the information block group being the same, and each information block corresponding to one or more UEs in the UE group, the length or format of each information block in the information block group being different, the information block group comprising a first information block and at least one second information block, wherein the first information block comprising UE group-common information, and each of the second information blocks comprising information of the one or more UEs in the UE group. For example, relationship between the second information blocks and the UEs may be one-to-one, one-to-many, many-to-one and so on. For example, each information block of the second information blocks corresponds to a different UE or a plurality of UEs. Or a plurality of information blocks of the second information blocks correspond to one UE.

In an implementation, wherein the UE group-common information comprising at least one of the following, system information modification indication information, earthquake and tsunami warning system and/or commercial mobile alarm service indication information, stop paging monitoring indication information.

In an implementation, wherein each information block in the information block group comprises information for indicating whether there is a next information block in the information block group after the information block, or information for indicating whether the information block is the last information block in the information block group.

In an implementation, wherein the UE determines a format of the data part by at least one of the following, system information indication, the signal sequence used by the synchronization part, the format of a data part is determined according to a serial number of the data part if there are multiple data parts after the synchronization part of the wake-up signal, a format of each of the data parts is indicated by its previous data part as one of predefined formats, blind detection of the UE.

In an implementation, wherein a transmission rate of the data part of the wake-up signal is determined by at least one of the following, the transmission rate of the data part of the wake-up signal being indicated by the system information, the transmission rate of the data part of the wake-up signal being determined by the signal sequence used by the synchronization part, blind detection of the UE, the transmission rate of the data part being determined according to duration of the synchronization part.

In an implementation, wherein a periodicity of the wake-up signal is determined by at least one of the following, the periodicity of the wake-up signal being indicated by system information, the periodicity of the wake-up signal being the same as the periodicity of a PO, the periodicity of the wake-up signal being configured by a core network, the minimum value between the periodicity of the wake-up signal configured by the core network and the periodicity of the wake-up signal configured by a base station being taken as the periodicity of the wake-up signal.

In an implementation, wherein a frequency domain resource location for the wake-up signal is determined by at least one of the following, an absolute radio frequency channel number, one or more frequency bands for wake-up signal reception reported by the UE to a base station, the UE binding frequency band information for wake-up signal reception through registration information, a Point A and a predefined or preconfigured offset, the frequency band where the PO is located.

In an implementation, wherein a guard bandwidth is set before the frequency domain resources for the wake-up signal and/or after the frequency domain resources for the wake-up signal.

In an implementation, wherein a transmission occasion of the wake-up signal is determined by at least one of the following, the starting point of the transmission occasion of the wake-up signal indicated by system information and/or a preconfigured first offset, a paging frame (PF) and/or a PO and/or a preconfigured second offset, PEI.

In an implementation, wherein relationship between the wake-up signal and an SSB is indicated by 1-bit information in system information.

In accordance with another aspect of the disclosure, a method performed by a base station is provided. The method includes transmitting a wake-up signal to a user equipment (UE), and transmitting paging-related information or a PDSCH to the UE or receiving a radio resource control (RRC) connection request from the UE based on the wake-up signal, wherein the wake-up signal is used to wake up the UE to receive the paging-related information or establish RRC connection or receive the PDSCH.

In accordance with another aspect of the disclosure, a communication device is provided. The communication device includes a transceiver configured to receive and/or transmit a signal, and a processor coupled with the transceiver and configured to perform the method according to an embodiment of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of an overall structure of a wireless network according to an embodiment of the disclosure;

FIGS. 2A and 2B are schematic block diagrams of a transmission path and a reception path according to various embodiments of the disclosure;

FIGS. 3A and 3B are structural schematic diagrams of a user equipment (UE) and a base station, respectively according to various embodiments of the disclosure;

FIG. 4 is a schematic diagram of a method according to an embodiment of the disclosure; and

FIG. 5 is a simplified hardware block diagram of a communication device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It should be understood that singular forms of “a”, “an,” and “the” include plural referents unless the context clearly indicates otherwise. Thus, for example, reference to “a component surface” includes reference to one or more of such surfaces.

The terms “include” or “may include” refer to the existence of a corresponding disclosed function, operation or component that may be used in various embodiments of the disclosure, without limiting the existence of one or more additional functions, operations or features. In addition, the terms “include” or “have” may be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning as those understood by those skilled in the art in this disclosure. General terms, as defined in dictionaries, are interpreted as having meanings consistent with the context in the relevant technical fields, and should not be interpreted in an idealized or overly formal way unless explicitly defined in this disclosure.

Technical solutions of embodiments of the disclosure may be applied to various communication systems, such as global system for mobile communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5^{th} generation (5G) system or new radio (NR), etc. In addition, the technical solutions of embodiments of the disclosure may be applied to future-oriented communication technologies.

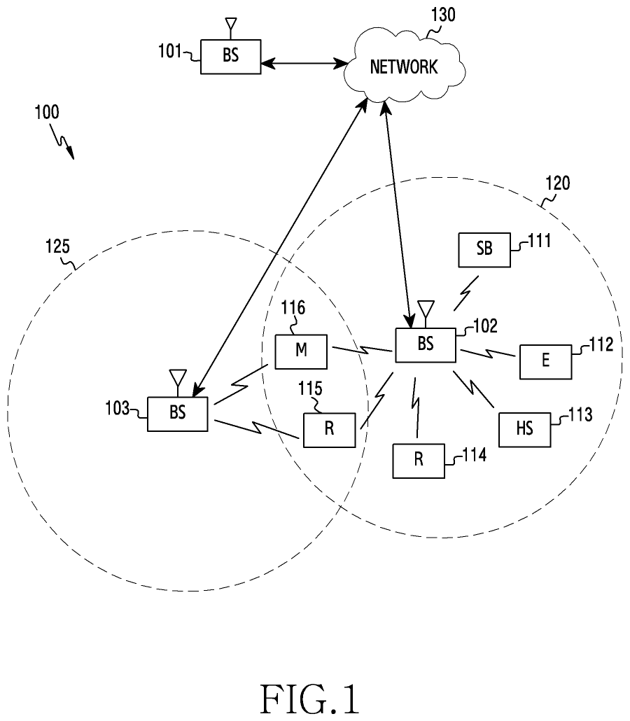

FIG. 1 illustrates an example wireless network 100 according to an embodiment of the disclosure. The embodiment of the wireless network 100 shown in FIG. 1 is for illustration only. Other embodiments of the wireless network 100 may be used without departing from the scope of the disclosure.

Referring to FIG. 1, the wireless network 100 includes a gNodeB (gNB) 101, a gNB 102, and a gNB 103. gNB 101 communicates with the gNB 102 and gNB 103. gNB 101 also communicates with at least one Internet protocol (IP) network 130, such as the Internet, a private IP network, or other data networks.

Depending on a type of the network, other well-known terms, such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UEs) within a coverage area 120 of the gNB 102. The first plurality of UEs include a UE 111, which may be located in a small business (SB), a UE 112, which may be located in an enterprise (E), a UE 113, which may be located in a wi-fi Hotspot (HS), a UE 114, which may be located in a first residence (R), a UE 115, which may be located in a second residence (R), a UE 116, which may be a mobile device (M), such as a cellular phone, a wireless laptop computer, a wireless personal digital assistant (PDA), or the like. GNB 103 provides wireless broadband access to network 130 for a second plurality of UEs within a coverage area 125 of gNB 103. The second plurality of UEs include a UE 115 and the UE 116. In some embodiments of the disclosure, one or more of gNBs 101-103 may communicate with each other and with UEs 111-116 using 5G, long term evolution (LTE), LTE-advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of the gNB 101, the gNB 102, and the gNB 103 include a two-dimensional (2D) antenna array as described in embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

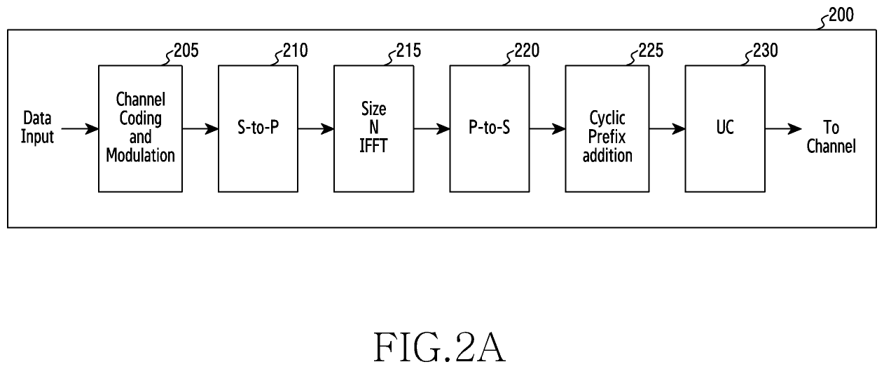

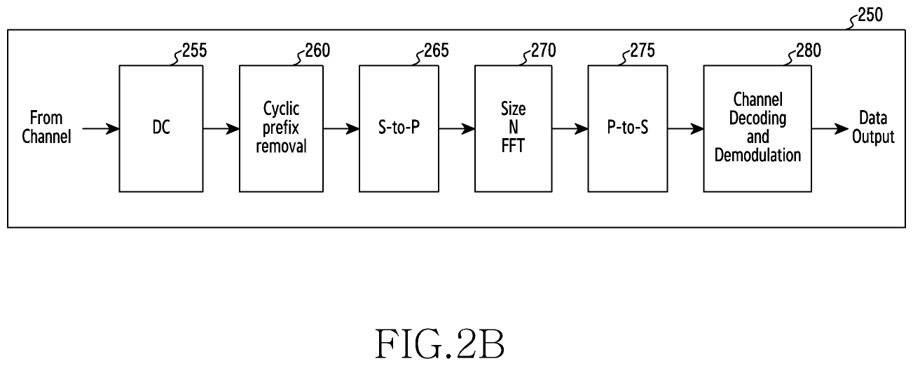

FIGS. 2A and 2B illustrate wireless transmission and reception paths according to various embodiments of the disclosure.

Referring to FIGS. 2A and 2B, in the following description, the transmission path 200 may be described as being implemented in a gNB, such as the gNB 102, and a reception path 250 may be described as being implemented in a UE, such as the UE 116. However, it should be understood that the reception path 250 may be implemented in a gNB and the transmission path 200 may be implemented in a UE. In some embodiments of the disclosure, the reception path 250 is configured to support codebook designs and structures for systems with 2D antenna arrays as described in embodiments of the disclosure.

Referring to FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. Referring to FIGS. 2B, the reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) for transmission via a wireless channel. The signal may also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms may be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that may be used in a wireless network. Any other suitable architecture may be used to support wireless communication in a wireless network.

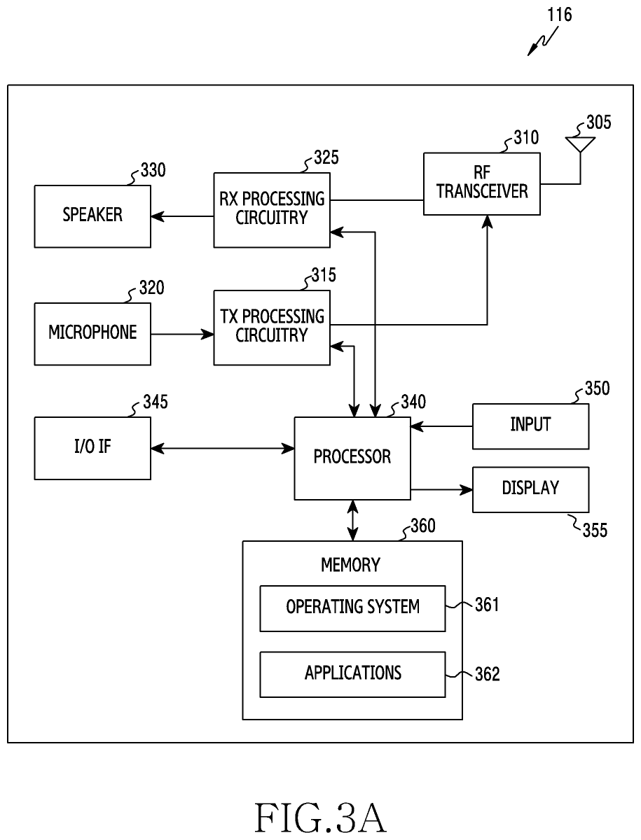

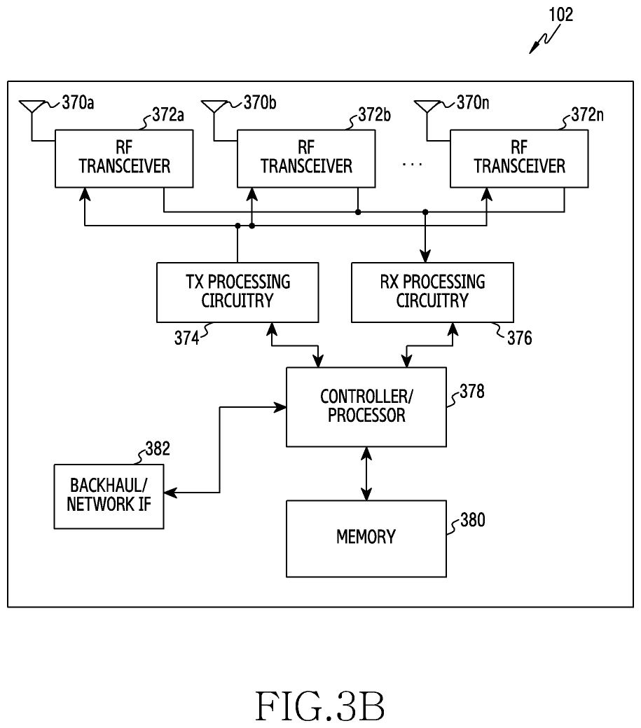

FIG. 3A illustrates a UE according to an embodiment of the disclosure. The embodiment of the UE 116 shown in FIG. 3A is for illustration only, and UEs 111-115 of FIG. 1 may have the same or similar configuration. However, a UE has various configurations, and FIG. 3A does not limit the scope of the disclosure to any specific implementation of the UE.

Referring to FIG. 3A, the UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactivated video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and perform an OS 361 stored in the memory 360 in order to control the overall operation of the UE 116. For example, the processor/controller 340 may control the reception of forward channel signals and the transmission of backward channel signals through the RF transceiver 310, the RX processing circuit 325 and the TX processing circuit 315 according to well-known principles. In some embodiments of the disclosure, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 may move data into or out of the memory 360 as required by an execution process. In some embodiments of the disclosure, the processor/controller 340 is configured to perform the application 362 based on the OS 361 or in response to signals received from the gNB or the operator. The processor/controller 340 is also coupled to an I/O interface 345, where the I/O interface 345 provides the UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 may input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of the UE 116, various changes may be made to FIG. 3A. For example, various components in FIG. 3A may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates a gNB 102 according to an embodiment of the disclosure. The embodiment of the gNB 102 shown in FIG. 3B is for illustration only, and other gNBs of FIG. 1 may have the same or similar configuration. However, a gNB has various configurations, and FIG. 3B does not limit the scope of the disclosure to any specific implementation of a gNB. It should be noted that gNB 101 and gNB 103 may include the same or similar structures as the gNB 102.

Referring to FIG. 3B, the gNB 102 includes a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactivated video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of the gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a blind interference sensing (BIS) process, such as that performed through a BIS algorithm, and decode a received signal from which an interference signal is subtracted. A controller/processor 378 may support any of a variety of other functions in the gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the disclosure. In some embodiments of the disclosure, the controller/processor 378 supports communication between entities, such as web real-time communications (RTCs). The controller/processor 378 may move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 may support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 may allow the gNB 102 to communicate with other gNBs through wired or wireless backhaul connections. When the gNB 102 is implemented as an access point, the backhaul or network interface 382 may allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 may include a RAM, while another part of the memory 380 may include a flash memory or other ROMs. In certain embodiments of the disclosure, a plurality of indication, such as the BIS algorithm, are stored in the memory. The plurality of indication are configured to cause the controller/processor 378 to perform the BIS process and decode the received signal after subtracting at least one interference signal determined by the BIS algorithm.

As will be described below, the transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 may include any number of each component shown in FIG. 3A. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, the gNB 102 may include multiple instances of each (such as one for each RF transceiver).

A time domain unit (also called a time unit) in the disclosure may be an orthogonal frequency division multiplexing (OFDM) symbol, an OFDM symbol group (including multiple OFDM symbols), a time slot, a time slot group (including multiple time slots), a subframe, a subframe group (including multiple subframes), a system frame and a system frame group (including multiple system frames), or the like, it may also be an absolute time unit, such as 1 millisecond, 1 second, or the like, the time unit may also be a combination of various granularities, such as N1 time slots plus N2 OFDM symbols.

A frequency domain unit (also called a frequency unit) in the disclosure may be a subcarrier, a subcarrier group (including multiple subcarriers), a resource block (RB) (also called a physical resource block (PRB)), a resource block group (including multiple RBs), a bandwidth part (BWP), a bandwidth part group (including multiple BWPs), a frequency band/carrier, a frequency band group/carrier group, or the like, it may also be an absolute frequency domain unit, such as 1 Hz, 1 kHz, or the like, the frequency domain unit may also be a combination of multiple granularities, such as M1 PRBs plus M2 subcarriers.

Various embodiments of the disclosure are further described below with reference to the accompanying drawings.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes may be made to the illustrated embodiments and examples without departing from the scope of this disclosure.

Transmission links of a wireless communication system mainly includes a downlink communication link from a 5G new radio (NR) gNB to a user equipment (UE), and an uplink communication link from a UE to a network, and a sidelink communication link from a UE to a UE.

In a wireless communication system, such as the current wireless communication system, in order to reduce energy consumption of a terminal side, a discontinuous reception (DRX) mechanism is introduced, such that a UE may be in a sleep state most of the time, and only needs to be waked up periodically to monitor a paging occasion (PO). In a DRX cycle, the UE only wakes up to monitor the PO during a DRX ON duration, and after a PDCCH scrambled with paging radio network temporary identifier (P-RNTI) is monitored, the UE continues to read a paged terminal identifier in a paging message, the UE further reads the paging message if the read terminal identifier is the same as its own identifier, otherwise discards the paging message. In the above procedure, in order to further reduce energy consumption of the UE, a paging early indication (PEI) signal is introduced to indicate whether the UE needs to monitor the corresponding PO. If system information provides PEI configuration, the UE monitors a PEI occasion once every DRX cycle, if the UE detects PEI and the PEI indicates to the UE to monitor an associated PO corresponding to the UE, the UE should wake up at the next PO to monitor the PO. Otherwise, the UE does not need to wake up to monitor the PO.

In some use cases (such as an Internet of things device and/or a wearable device) where requirements on low energy consumption of the UE are stricter, in order to further extend the battery life of the UE, the wireless communication system may use a low-power wake-up signal (LPWUS) to wake the UE to monitor the corresponding PO or establish RRC connection or receive a PDSCH. However, how to perform UE operations related to the wake-up signal is an issue that needs to be addressed. For example, the structure and function, configuration and transmission details of the wake-up signal, behaviors of the UE after the wake-up signal is received, fallback mechanism for the wake-up signal and relationship between the wake-up signal and a beam are all issues that need to be addressed. It should be understood that for simplicity of description, descriptions of low-power-consumption wake-up signal, low-power wake-up signal, LPWUS, LP-WUS, etc. are used throughout description of the disclosure, but these names are not intended to limit the names of the wake-up signal to which the disclosure applies. Rather, such a wake-up signal may also have other names, as long as it may implement functions that the wake-up signal (for example, LPWUS) described in this disclosure may implement, it falls within the scope of this disclosure.

In the disclosure, a configuration and transmission method of a low-power-consumption wake-up signal and a corresponding device will be introduced. In an embodiment of the disclosure, the structure, function, configuration and transmission details of the LPWUS, UE behaviors after LPWUS detection, fallback mechanism for the LPWUS, and relationship between the LPWUS and a beam will be introduced. In this embodiment of the disclosure, the LPWUS is used for an introduction, and the introduced method may also be used to wake up the UE for paging reception, establishing RRC connection or receiving a PDSCH.

According to an embodiment of the disclosure, a receiver of the UE includes two modules, one is a primary communication receiver (PCR) for receiving a signal/channel of the related art transmitted by a base station, and the other is a lower power wake up receiver (LPWUR) for receiving the LPWUS transmitted by the base station, the reason why a dedicated module is used to receive the LP-WUS is because the LPWUS is of a waveform based on on-off keying (OOK) modulation, that is, different from a waveform based on orthogonal frequency division multiplexing (OFDM) system of the existing NR system, the LPWUR may monitor the LPWUS with extremely low power, and once the LPWUS is monitored by the UE, the LPWUR may trigger the primary communication receiver (PCR) transition from off state to ON state, thereby specific operations may be performed.

According to an embodiment of the disclosure, the UE may only monitor the LPWUS during the DRX off state. For example, the UE may only monitor LPWUS during a predefined or preconfigured time before the starting position of the DRX cycle, and the starting point of the predefined time is the starting time for LPWUS monitoring, the starting time is determined by the starting position of the DRX cycle and a preconfigured offset; or the UE may monitor LPWUS continuously, since the power consumption for LPWUS monitoring is extremely low compared with the power consumption caused by frequent on and off of the LPWUS reception module, and monitor LPWUS continuously will not bring large power consumption.

According to an embodiment of the disclosure, the UE may be waked up by the LPWUS at a specific position to receive paging-related information (for example but not limited to the PEI or the PO or the paging message, which are described as examples of the paging-related information in the description of the disclosure) or establish RRC connection or receive the PDSCH. The specific position may be any position within a LPWUS cycle. Optionally, if the UE receives the LPWUS at the ending position of the LPWUS cycle or during a preset time before the ending position of the LPWUS cycle, the UE wakes up at the first or the latest time unit after LPWUS reception, or wakes up at the starting position of the next LPWUS cycle to monitor the PEI or the PO or receive the paging message.

According to an embodiment of the disclosure, the LPWUS may indicate whether the UE needs to monitor the corresponding PO or receive the paging message at the corresponding PO, if the system information provides LPWUS configuration, the UE monitoring LPWUS once every DRX cycle, and if the UE detects the LPWUS and the LPWUS indicates to the UE to monitor the associated PO, the UE should wake up at the next PO to monitor the PO. Otherwise, the UE does not need to wake up to monitor the PO. It should be understood that in this disclosure, although it is described that the LPWUS indicates to the UE to monitor the associated PO, the description may also cover that the LPWUS may directly indicate the UE to receive the paging message at the associated PO.

According to an embodiment of the disclosure, the LPWUS may include a synchronization part and a data part, wherein the data part may send all or a part of the paging message of the UE, inform the UE to perform corresponding operations, such as waking up the primary receiver of the UE to receive data or signals, and/or performing parameter update, and/or triggering random access procedure of the UE. The indication field of the LPWUS data part may contain one or more of the followings:
List of the paged UEs pagingRecordList, with value of the sequence of pagingrecord, pagingrecord contains ue-Identity and/or accessType. ue-Identity may uniquely specify a UE, including serving temporary mobile subscriber identity (S-TMSI) and/or inactive RNTI (I-RNTI), wherein S-TMSI is a temporary UE identification number and I-RNTI is used for identification of the identity information of a terminal device and identification of the identity information of a serving base station. Optionally, only the UE in RRC_INACTIVE and/or RRC_IDLE state reads the information in pagingRecordList;
Late non-critical extension lateNonCriticalExtension;
   Non-critical extension nonCriticalExtension, containing pagingRecordList-v1700 and/or pagingGroupList-r17 field. Wherein the value of pagingRecordList-v1700 is the sequence of PagingRecord-v1700, and the value of pagingGroupList-r17 is the sequence of temporary group flag TMGI-r17;
System information modification systemInfoModification, indicating the update of broadcast channel messages except for SIB6, SIB7 and SIB8 if set to 1;
Earthquake and tsunami warning system and commercial mobile alarm service indication etwsAndCmaslndication, indicating earthquake and tsunami warning system (ETWS) primary notification and/or ETWS secondary notification and/or commercial mobile alarm service (CMAS) notification if set to 1;
Stop paging monitoring stopPagingMonitoring indication, indicating the UE to stop monitoring the PDCCH transmission occasion paged in the PO if set to 1;

The structure of the LPWUS may include one or a combination of the followings:
The LPWUS signal may be divided into two parts: a synchronization part (WUS-SYNC) and a data part (WUS-DATA), the synchronization part may be including a (pre-)defined physical signal sequence or repetitions of the physical signal sequence, and/or including a sequence of a variety of (pre-)defined physical signal sequences or repetitions of the sequence, and the network side (e.g., the base station) may select a sequence from the variety of (pre-)defined physical signal sequences as a signal sequence of the synchronization part. The UE may determine(or identify) the signal sequence of the synchronization part in specific methods, which include at least one of the followings:

The physical signal sequence is preconfigured by the base station. For example, the signal sequence may be indicated by system information, such as system information block (SIB) message.

The physical signal sequence is determined according to at least one of a cell physical ID, a UE ID, a P-RNTI value of the UE, and an index of a radio frame/time slot/symbol where the WUS-SYNC is located, wherein the UE ID is preconfigured by the base station or determined according to S-TMSI number of the UE;

The physical signal sequence is determined by blind detection of the UE.

The physical signal sequence is determined according to the signal sequence (pre)configured by the base station during the latest time the UE was in radio resource control connected state (RRC connected state), for example, the physical signal sequence is the same as the signal sequence.

The UE ensures UE synchronization by detecting the synchronization part of the LPWUS, so as to ensure correct reception and decoding of the data part. The data part is mainly used to carry indication information to wake up the UE and/or part or all of information included in the paging message. For example, the data part may contain identity information or identification (ID) information of one or more UEs or one or more UE groups. A format of the data part may be fixed, for example, there is only one predefined format for the data part, and a data bit length of the predefined format is R, where R is a parameter value predefined or (pre)configured by the base station, and R is a real number greater than 0, and/or the data part may have multiple formats, each format has different data bit lengths, that is, contains different indication fields. The UE may determine(or identify) the format of the LPWUS data part in specific methods, which include at least one of the followings:
The format of the LPWUS data part is selected by the base station from preconfigured formats, for example, the selected format may be indicated by system information, such as SIB message;
The format of the LPWUS data part is implicitly indicated by the physical signal sequence used by the WUS-SYNC;
The format of the LPWUS data part is determined according to serial numbers in multiple WUS-Datas, for example, a WUS-SYNC is followed by multiple WUS-Data information blocks, and it may be specified in the specification that the format of the first WUS-Data block is L1, and the format of the remaining WUS-Data blocks is L2, wherein L1 and L2 may be the same or different, and are specified values;

The format of a LPWUS data part is indicated by the previous WUS-Data among one of a plurality of predefined WUS-Data formats.

The format of the LPWUS data part is determine by blind detection of the UE;
The LPWUS signal data part may contain only an UE-specific information block, or it may also contain N1 information blocks corresponding to N1 UEs, for example, information blocks (information block group) for a group of UEs, wherein an UE-specific information block, N1 is a parameter value predefined or (pre)configured by the base station, and N1 is a real number greater than 0. Grouping methods of UEs supporting the LPWUS may include one or more of the followings:

A subgroup specified by a core network. The UE is assigned a subgroup ID (between 0 and 7) based on non-access stratum (NAS) signalling from access and mobility management function (AMF), and the UE belonging to the specified subgroup ID monitors its associated LPWUS which indicates a paging subgroup.

UE ID based grouping. The UE subgroup ID is indicated implicitly, for example, the subgroup ID of the UE is equal to (floor(UE_ID/(N*Ns)) mod subgroupsNumForUEID)+(subgroupsNumPerPO−subgroupsNumForUEID), wherein floor represents a lower bound of rounding, UE_ID is equal to S-TMSI mod X, S-TMSI is a temporary UE identification number, X is a predefined value, N is the number of total paging frames in duration T, Ns is the number of POs for a paging frame, subgroupsNumPerPO represents the number of subgroups based on core network designation and UE_ID grouping in a PO, and subgroupsNumForUEID represents the number of subgroups for UE_ID based subgrouping in a PO. The UEs belonging to the specified subgroup ID monitor their associated LPWUS, which indicates the paging subgroup. Wherein T is determined by the shortest value among UE-specific DRX values, and T is a real number greater than 0.

If the LPWUS signal data part contains information blocks for multiple UEs, the format of each information block may be configured as a combination of one or more of the followings:

The formats of each of the information blocks may be the same. Optionally, the UE only needs to decode the information block corresponding to itself according to higher-level signalling or base station indication, and does not need to decode the information blocks corresponding to other UEs. Optionally, when the UE ID carried in the higher-level signalling or the base station indication is the same as the local UE ID, the UE determines that a certain information block is an information block for itself, and the UE only decodes the information block corresponding to itself, without decoding the information blocks corresponding to other UEs.

The formats of each of the information blocks may be different. Optionally, the first information block of the data part after the synchronization part may be a common configuration field containing a group of UE-common data information, and the information blocks starting from the second information block of the data part are for UE-specific data information. Optionally, the common configuration field may include systemInfoModification modification, which indicates the update of other broadcast channel messages except for SIB6, SIB7 and SIB8 if set to 1, and/or an earthquake and tsunami warning system and commercial mobile warning service indication etwsAndCmaslndication, which indicates the earthquake and tsunami warning system (ETWS) primary notification and/or the ETWS secondary notification and/or commercial mobile alert service (CMAS) notification if set to 1, and/or a stop paging monitoring stopPagingMonitoring indication, which indicates the to UE to stop monitoring the PDCCH transmission occasion paged in the PO if set to 1;

The information bits of each information block in the data part contains a plurality of indication fields, and optionally, a field for indicating the existence or absence of the next information block or a field for indicating whether this information block is the last information block is included. For example, 1 bit is used to indicate the existence or absence of the next information block, indicating that the next information block exists if the bit is 1, and indicating that the next information block does not exist if the bit is 0, or 1 bit is used to indicate whether the information block is the last information block or not, indicating that the information block is the last information block if the bit is 1, and otherwise if the bit is 0.
In an embodiment of the disclosure, the WUS-DATA signal may have multiple transmission rates. The WUS-DATA may be transmitted at a transmission rate selected from multiple signal transmission rates, and the UE may determine(or identify) the transmission rate of the WUS-DATA in specific methods, which include at least one of the followings:
A transmission rate indication is selected from preconfigured transmission rates by the base station, wherein the transmission rate of the WUS-DATA may be indicated by system information, such as SIB;
The transmission rate is indicated implicitly by the physical signal sequence used by the synchronization part. For example, if the synchronization part uses two different waveforms, 1-bit indication information may be carried implicitly to indicate two different transmission rates of the data part.

The transmission rate is determined by blind detection of UE;
In an embodiment of the disclosure, the data rate of the WUS-DATA is determined according to the duration of the WUS-SYNC. Optionally, the data rates of a plurality of WUS-DATAs are determined according to the duration of the WUS-SYNC.

Configuration methods for the LPWUS periodicity may include one or a combination of the followings:
The LPWUS periodicity is configured separately, and the currently configured LPWUS periodicity is indicated by the base station through system information, such as SIB;
The LPWUS periodicity is configured according to the periodicity of the paging occasion (PO), for example, consistent with the periodicity of the PO, that is, equal to the periodicity of the PO;
The LPWUS periodicity is determined according to the paging frame (PF) and/or the paging occasion (PO). Optionally, the system frame number (SFN) satisfying the equation (SFN+PF_offset) mod T=(T div N)*(UE_ID mod N) may be used as a paging frame, wherein T is the DRX cycle of the UE, N is the number of total paging frames with the duration T, UE_ID is equal to (IMSI mod 1024), and IMSI is the international mobile subscriber identity which may be used for determining a unique UE. An index i_s indicates the index of the paging occasion, wherein i_s=floor (UE_ID/N) mod Ns, floor is a lower bound of rounding, and Ns is the number of POs in a paging frame.
The LPWUS periodicity is configured by the core network;
The current LPWUS periodicity is taken as the minimum value of the LPWUS periodicities configured by the base station and by the core network;

A frequency domain resource location for transmitting the LPWUS may include one or a combination of the followings:
A frequency domain resource location for the LPWUS may be bound with an absolute radio frequency channel number (ARFCN), and the base station may broadcast the frequency band supporting the transmission of the LPWUS to the UE; and/or
The UE reports one or more supported frequency bands for LPWUS reception to the base station, and the base station selects one of the reported frequency bands to transmit the LPWUS;
When the UE is connecting to the base station, it binds specific frequency band information for LPWUS reception through one-time registration information, such as a NAS ID (corresponding to a unique UE ID) or I-RNTI of the UE;
The frequency domain resource location for the LPWUS may be calculated from a Point A calculated from the SSB subcarrier offset carried by main information block and the offset from the Point A OffsetToPointA and a predefined or preconfigured offset, the granularity of the predefined or preconfigured offset is a subcarrier or a physical resource block (PRB);
The frequency domain resource location for the LPWUS may be bound with the frequency band where the PO is located.

In an implementation, in order to reduce impact of the LPWUS on non-LPWUS users, a guard bandwidth of G kHz may be added before and/or after the frequency domain resources mapped by the LPWUS signal to avoid inter-carrier interference, where G is a parameter value predefined or (pre)configured by the base station, and G is a real number greater than 0.

Methods for determining a transmission occasion of the LPWUS may include one or a combination of the followings:
The time unit where the transmission occasion of the LPWUS is located is indicated by the starting point of the transmission occasion of the LPWUS indicated by the system information and/or an offset. For example, the time unit where the transmission occasion of the LPWUS is located is indicated by the starting point of the transmission occasion of the LPWUS indicated in SIB message adding a fixed offset P, wherein P is a parameter value predefined or (pre)configured by the base station and P is a real number greater than 0;
The transmission occasion of the LPWUS is indicated according to the paging frame (PF) and/or the paging occasion (PO) and/or an offset, the offset is a parameter value predefined or (pre)configured by the base station.
The time unit where the transmission occasion of the LPWUS is located is indicated by the PEI, and the UE periodically monitors the PEI occasion once every DRX cycle. If the UE detects the PEI indication and the PEI indicates to the UE to monitor the associated LPWUS transmission occasion, the UE should wake up at the next LPWUS transmission occasion to monitor the LPWUS. Otherwise, the UE does not need to wake up to monitor the LPWUS. Different from the PEI indicating PO transmission occasion, monitoring the LPWUS does not need continuous PDCCH monitoring, and may directly receive the paging message in the data part of the LPWUS, thus can further reduce the power consumption of the UE.

After the UE receives the LPWUS, UE behaviors may include one or more of the followings:
UE wakes up to monitor the PEI to determine which PO to wake up to receive the paging message;
If the UE receives the LPWUS and the LPWUS indicates to the UE to monitor the associated PO, the UE should wake up at the next PO to monitor the PO or receive the paging message at the PO. Otherwise, the UE does not need to wake up to monitor the PO. Optionally, when the LPWUS replaces the PEI indication to wake up the UE to receive the paging message, the UE does not need to monitor the PEI periodically, thus reducing the power consumption for monitoring the PEI.
UE receives part or all of the information of the paging message transmitted in the data part of the LPWUS and wake up, and/or further receives the information of the extended N bits of the paging message transmitted in the PDSCH. Optionally, the UE receives part or all of the information of the paging message transmitted in the LPWUS data part in the latest DRX cycle and wake up, and/or receives the information of the extended N bits of the paging message transmitted in the PDSCH, N is a parameter value reported by the user equipment (UE) according to its own processing capability and/or a parameter value configured by the base station and received by the UE and/or a preconfigured parameter value.
UE receives a part of the information of the paging message transmitted in the data part of the LPWUS and wake up to receive another part of the information of the paging message. For example, the part of the information of the paging message transmitted in the data part of the LPWUS may be information in the above-mentioned common configuration field, which includes systemInfoModification modification, which indicates the update of other broadcast channel messages except for SIB6, SIB7 and SIB8 if set to 1, and/or an earthquake and tsunami warning system indication etwsAndCmaslndication, which indicates the earthquake and tsunami warning system (ETWS) primary notification and/or the ETWS secondary notification and/or commercial mobile alert service (CMAS) notification if set to 1, and/or stop paging monitoring stopPagingMonitoring indication, which indicates to the UE to stop to monitor the PDCCH transmission occasion paged in the PO if set to 1. Optionally, the UE receives the part of the information of the paging message transmitted in the data part of the LPWUS in the latest DRX cycle and wake up to receive another part of the information of the paging message;
UE wakes up to receive the paging message, and if data needs to be transmitted at this time, enters RRC connected state after the paging occasion;
UE wakes up and receive the paging message transmitted in the data part of the LPWUS. If data transmission is needed at this time, then the UE enters RRC connected state. Optionally, when the LPWUS replaces the paging message, UE receive the LPWUS and decode the paging message from the WUS-DATA, and decide whether to establish RRC connection or not, and enter RRC connected state. At this time, the UE does not need to monitor or receive other signals or channels, and the power consumption is the lowest compared with other solutions.
UE wakes up to establish RRC connection;
UE wakes up to receive an SSB;
UE wakes up to receive a PDSCH, and optionally, UE wake up to receive the PDSCH transmitted through small data transmission (SDT); the PDSCH transmitted through SDT may be a PDSCH configured semi-statically;
UE wakes up to monitor a PDCCH;
It should be understood that the paging message described above in connection with behaviors of the UE may refer to the PAGING message transmitted by the system or some or all information included in the PAGING.

The fallback mechanism for the LPWUS may include one or a combination of the followings:
If the duration for no wake-up signal reception exceeds D time units, the UE wakes up to monitor the PEI or receive the paging message after the D time units. Wherein D is a parameter value predefined or (pre)configured by the base station, and D is a real number greater than 0.
If the RSRP change range of the LPWUS exceeds a first threshold at the receiving end, optionally, if the RSRP of the LPWUS received by the receiving end in the current time unit is worse than that in a reference time unit and the change range exceeds the first threshold, or the absolute value of the RSRP is lower than a second threshold, the UE wakes up to monitor the PEI or receive the paging message by itself. Wherein, the first threshold value or the second threshold value is a parameter value predefined or (pre)configured by the base station.
Optionally, if the UE monitors the PEI indicates to the UE not monitor the associated PO for I time units, or the UE does not detect its own PO when the PEI indication is not used, the UE stops monitoring the PEI or the paging message and restarts the LPWUS mechanism. Wherein I is a parameter value predefined or (pre)configured by the base station and I is a real number greater than 0.

The relationship between the LPWUS and the SSB may be configured or indicated by the system information, such as SIB message, and optionally, 1-bit information may be configured in the SIB message to indicate whether the LPWUS and the SSB have quasi co location (QCL) relationship. When the 1-bit information is 1, the LPWUS and the SSB have QCL relationship. At this time, if the UE needs to receive the SSB after detect the LPWUS, the UE does not need to reperform beam sweeping, and only needs to use the beam direction associated with the LPWUS for SSB transmission. When the 1-bit information is 0, the LPWUS and the SSB do not have QCL relationship. If the UE needs to receive the SSB after detect the LPWUS, the UE needs to reperform beam sweeping to acquire the beam direction for SSB transmission.

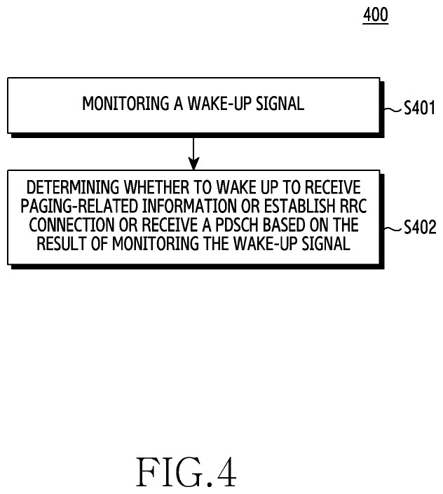

FIG. 4 illustrates a schematic diagram of a method 400 performed by a user equipment (UE) in a communication system according to an embodiment of the disclosure. Referring to FIG. 4, the method 400 includes:
401: Monitoring a wake-up signal, and
402: determining whether to wake up to receive paging-related information or establish radio resource control (RRC) connection or receive a physical downlink shared channel (PDSCH) based on the result of monitoring the wake-up signal.

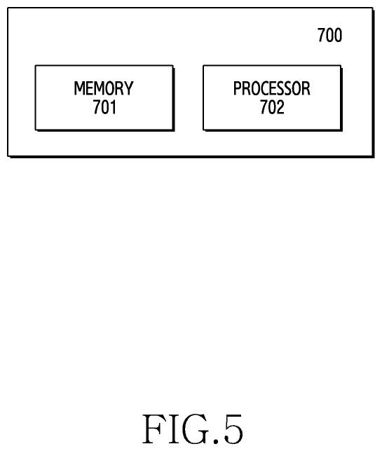

FIG. 5 is a simplified hardware block diagram of a communication device according to an embodiment of the disclosure.

Referring to FIG. 5, an embodiment of the disclosure also provides a communication device (base station or user equipment (UE)) 700. The communication device includes a memory 701, a processor 702 and a transceiver 703. The processor 702 is coupled with the transceiver 703 and the memory 701. Computer executable instructions are stored at the memory, which, when executed by the processor 702, cause at least one method corresponding to the above-mentioned embodiments of the disclosure to be performed. The above are only various embodiments of the disclosure, and are not used to limit the disclosure. Any modification, equivalent replacement, improvement, etc. made within the spirit and principle of the disclosure should be included in the scope of protection of the disclosure.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any processor of the related art, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

Those skilled in the art will understand that the disclosure includes devices for performing one or more of the operations described in the disclosure. These devices may be specially designed and manufactured for required purposes, or they may also include known devices in general-purpose computers. These devices have computer programs stored therein, which are selectively activated or reconfigured. Such computer programs may be stored in a device (e.g., a computer) readable medium including but not limited to any type of disk (including floppy disk, hard disk, optical disk, compact disc (CD)-ROM, and magneto-optical disk), a read-only memory (ROM), a random access memory (RAM), an erasable programmable read-only memory (EPROM), an electrically erasable programmable read-only memory (EEPROM), a flash memory, a magnetic card or an optical card. For example, the readable medium includes any medium in which information is stored or transmitted by a device (e.g., a computer) in a readable form.

The steps of the method or algorithm described in this disclosure may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

Those skilled in the art will understand that each block in these structural diagrams and/or block diagrams and/or flow diagrams and combinations of blocks in these structural diagrams and/or block diagrams and/or flow diagrams may be implemented with computer program instructions. It may be understood by those skilled in the art that these computer program instructions may be provided to a processor of a general-purpose computer, a dedicated computer or other programmable data processing methods for implementation, so that the scheme specified in the block or blocks of the structure diagram and/or block diagram and/or flow diagram disclosed in the disclosure may be performed by the processor of the computer or other programmable data processing methods.

Those skilled in the art may understand that steps, measures and schemes in various operations, methods and processes that have been discussed in the disclosure may be alternated, changed, combined or deleted. Further, other steps, measures and schemes in various operations, methods and processes already discussed in the disclosure may also be alternated, changed, rearranged, decomposed, combined or deleted. Further, steps, measures and schemes in various operations, methods and processes disclosed in the disclosure in the prior art may also be alternated, changed, rearranged, decomposed, combined or deleted.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
monitoring a wake-up signal; and
determining whether to wake up to receive paging-related information or establish radio resource control (RRC) connection or receive a physical downlink shared channel (PDSCH) based on a result of monitoring the wake-up signal.

2. The method of claim 1,
wherein the UE monitors the wake-up signal continuously, or
wherein the UE monitors the wake-up signal during a predefined or preconfigured time period before a discontinuous reception (DRX) cycle.

3. The method of claim 2, wherein the predefined time period is determined based on a starting position of the DRX cycle and a preconfigured offset.

4. The method of claim 1, wherein, in the determining of whether to wake up to receive paging-related information or establish radio resource control (RRC) connection or receive a physical downlink shared channel (PDSCH) based on the result of the monitoring of the wake-up signal, at least one of the following is performed if the UE detects the related wake-up signal:
the UE wakes up to monitor paging early indication (PEI) to determine whether to wake up at a paging occasion (PO) of the UE to receive a paging message;
the UE receives part or all of information of the paging message transmitted by a data part of the wake-up signal in the current or the latest DRX cycle and wakes up, and/or receives the paging-related information in the PDSCH;
the UE receives the paging-related information in the data part of the wake-up signal in the current or the latest DRX cycle and wake up to receive part of information of the paging message;
the UE wakes up to establish RRC connection;
the UE wakes up to receive a synchronization signal block (SSB);
the UE wakes up to receive the PDSCH; and
the UE wakes up to monitor a physical downlink control channel (PDCCH).

5. The method of claim 4, wherein, if the UE detects the wake-up signal and the wake-up signal indicates to the UE to receive the paging-related information or establish RRC connection or receive the PDSCH, then:
the UE wakes up at a first or the latest time unit after receiving the wake-up signal to monitor or receive the paging-related information, or
the UE wakes up at a starting position of a next wake-up signal cycle and monitor or receive the paging-related information.

6. The method of claim 1, wherein the paging-related information comprises at least one of paging early indication (PEI), a paging occasion (PO) and a paging message.

7. The method of claim 1,
wherein the wake-up signal comprises a synchronization part and a data part, and
wherein the UE determines a signal sequence of the synchronization part by at least one of the following:
system information,
at least one of identification information of a cell where the UE is located, identification information of the UE, and an index of a radio frame or time slot or symbol where the synchronization part is located,
blind detection of the UE, and
the signal sequence configured during the latest time the UE was in radio resource control (RRC) connected state.

8. The method of claim 7, wherein the data part comprises part or all of indication information and/or a paging message to wake up the UE.

9. The method of claim 7, wherein an indication field of the data part comprises at least one of the following:
a list of a paged UEs pagingRecordList comprising a UE identification ue-Identity and/or an access type accessType;
a late non-critical extension lateNonCriticalExtension;
a non-critical extension nonCriticalExtension;
system information modification;
an earthquake and tsunami warning system etwsAndCmaslndication and/or commercial mobile alarm service indication commercial mobile alert service; and
a stop paging monitoring stopPagingMonitoring indication.

10. The method of claim 7, wherein the data part comprises a UE-specific information block or a UE group information block group, wherein the UE group is at least one of the following:
a subgroup specified by a core network; and
a subgroup based on UE identification (ID).

11. The method of claim 10,
wherein the information block group is at least one of the following:
length and/or format of each information block in the information block group being the same, and each information block corresponding to one or more UEs in the UE group,
length or format of each information block in the information block group being different, and
the information block group comprising a first information block and at least one second information block,
wherein the first information block comprising UE group-common information, and
wherein each of the second information blocks comprising information of one or more UEs in the UE group.

12. The method of claim 11, wherein the UE group-common information comprising at least one of the following:
system information modification indication information;
earthquake and tsunami warning system and/or commercial mobile alarm service indication information; and
stop paging monitoring indication information.

13. The method of claim 10, wherein each information block in the information block group comprises:
information for indicating whether there is a next information block in the information block group after the information block, or
information for indicating whether the information block is the last information block in the information block group.

14. The method of claim 7, wherein the UE determines a format of the data part by at least one of the following:
system information indication;
the signal sequence used by the synchronization part;
a format of a data part is determined according to a serial number of the data part if there are multiple data parts after the synchronization part of the wake-up signal;
a format of each of the data parts is indicated by its previous data part as one of predefined formats; and
blind detection of the UE.

15. The method of claim 7, wherein a transmission rate of the data part of the wake-up signal is determined by at least one of the following:
the transmission rate of the data part of the wake-up signal being indicated by the system information;
the transmission rate of the data part of the wake-up signal being determined by the signal sequence used by the synchronization part;
blind detection of the UE; and
the transmission rate of the data part being determined according to duration of the synchronization part.

16. The method of claim 1, wherein a periodicity of the wake-up signal is determined by at least one of the following:
the periodicity of the wake-up signal being indicated by system information;
the periodicity of the wake-up signal being the same as the periodicity of a paging occasion (PO);
the periodicity of the wake-up signal being configured by a core network; and
the minimum value between the periodicity of the wake-up signal configured by the core network and the periodicity of the wake-up signal configured by a base station being taken as the periodicity of the wake-up signal.

17. The method of claim 1, wherein a frequency domain resource location for the wake-up signal is determined by at least one of the following:
an absolute radio frequency channel number;
one or more frequency bands for wake-up signal reception reported by the UE to a base station;
the UE binding frequency band information for wake-up signal reception through registration information;
a Point A and a predefined or preconfigured offset; and
a frequency band where a paging occasion (PO) is located.

18. The method of claim 1, wherein a transmission occasion of the wake-up signal is determined by at least one of the following:
a starting point of the transmission occasion of the wake-up signal indicated by system information and/or a preconfigured first offset;
a paging frame (PF) and/or a paging occasion (PO) and/or a preconfigured second offset; and
paging early indication (PEI).

19. The method of claim 1, wherein relationship between the wake-up signal and an SSB is indicated by 1-bit information in system information.

20. A method performed by a base station, the method comprising:
transmitting a wake-up signal to a user equipment (UE); and
transmitting paging-related information or a physical downlink shared channel (PDSCH) to the UE or receiving a radio resource control (RRC) connection request from the UE based on the wake-up signal,
wherein the wake-up signal is used to wake up the UE to receive the paging-related information or establish RRC connection or receive the PDSCH.
